(19) United States
(12) Patent Application Publication
(10) Pub. No.: US 2026/0110520 A1
(43) Pub. Date: Apr. 23, 2026

(54) COMPOSITION HAVING SELF-REINFORCED POLYPROPYLENE COMPOSITE LAMINATED TO STRETCH WOVEN NYLON WITH NIR COMPLIANT CAMOUFLAGE PATTERNS, AND METHOD OF MANUFACTURING SAME

(71) Applicant: Brand & Oppenheimer Co., Inc., Portsmouth, RI (US)

(72) Inventors: Geoff Senko, Portsmouth, RI (US); Bryan Boulis, Portsmouth, RI (US); Benjamin Galpen, Portsmouth, RI (US)

(73) Assignee: Brand & Oppenheimer Co., Inc., Portsmouth, RI (US)

(21) Appl. No.: 19/362,986

(22) Filed: Oct. 20, 2025

Related U.S. Application Data
(60) Provisional application No. 63/710,949, filed on Oct. 23, 2024.

(51) Int. Cl. F41H 5/04; B32B 5/26; B32B 37/06

(52) U.S. Cl. CPC F41H 5/0478; B32B 5/263; B32B 37/06; B32B 2262/0253; B32B 2262/0261; B32B 2307/56; B32B 2571/02

(57) ABSTRACT

The laminated material and process for manufacturing thereof includes the combination of self-reinforced polypropylene and stretch woven nylon, or other materials alone or in combination with other materials, secured to each other by a fusable web. The material of the present invention provides a significantly lighter material compared to traditional raw materials thereby reducing the weight of tactical gear components and products, enhancing user mobility and lethality while improving durability to provide products that are greatly improved compared to NIR-compliant armor products made by conventional processes.

### CROSS-REFERENCE TO RELATED APPLICATIONS

This patent document claims priority to earlier filed U.S. Provisional Patent Application Ser. No. 63/710,949, filed Oct. 23, 2024, the entire contents of which are incorporated herein by reference.

### BACKGROUND OF THE INVENTION

The method, device and composition of the present invention relates to the textile industry. In particular, the present invention relates to the textiles, fabrics and other materials in the body armor field, such as for use for vests, pouches, placards, attachments, and the like.

In the prior art, fabrics and textiles for use in body armor are well known. However, the manufacture and use of such fabrics and textile for use with body armor that is near-infrared (NIR) compliant, for blending into a surrounding environment, can be difficult and expensive to manufacture which results is unacceptably heavy and stiff materials. This is particularly problematic in military applications where flexibility and light weight are critical features.

More specifically, current NIR-compliant materials for armor are too heavy, use too much material, are not durable and has too many manufacturing steps resulting in a very expensive and inferior art article.

Therefore, there is a need for an armor material that is NIR-compliant that is less expensive compared to known armor materials.

There is a further need for an armor material that uses less materials than prior art known armor fabrics and materials.

There is yet another need for a an armor material that utilizes precise laser cut patterns for various armor articles, such as vests, pouches, and other attachments.

Further, there is a need for armor materials and articles that use lighter weight raw materials.

There is a need for armor materials that are more durable than currently known materials for such use.

There is a need for a process to manufacture such materials that is more efficient and faster than currently known processes.

There is a need for reducing manufacturing steps and to maintain NIR capability after lamination.

There is yet another need to reduce delamination in end items.

### SUMMARY OF THE INVENTION

The present invention provides a new process, article, composition, and device that is new and novel and addresses the problems associated with known processes, articles, compositions, and devices.

Reducing weight of body armor vests, pouches, and other attachments are essential tools for military and law enforcement personnel. The performance of such gear is crucial for the safety and effectiveness of the wearer.

The present invention provides a multi-layer lamination composition with a self-reinforced polypropylene base that is bonded to a stretch woven nylon layer to result in a significantly lighter material compared to traditional raw materials thereby reducing the weight of products that require such characteristics. For example, tactical gear products, namely body armor, are particularly well-suited for the composition of the present invention to enhance user mobility and lethality without compromising performance and protection.

The present invention overcomes the known problems and disadvantages of currently available products, which includes the use of heavy and expensive raw materials that are not durable and which are not suitable for forming into precise shapes and patterns. The present invention provides a more durable lamination that is light and easily laser cut and sewn into different shapes and patterns for flexibility of incorporation into a final end product configuration. This streamlines the manufacturing processes, reduces costs, and enhances production efficiency.

Near-infrared compliance is vital to the stealth of the wearer and is required in many applications, such as military uses. Maintaining near-infrared compliance in accordance with such military specification for camouflage patterns is critical while maintaining all of the desired features and advantages discussed herein. As discussed in detail below, the present invention provides a new and novel lamination that is far superior compared to prior art materials for NIR-compliant materials. The present invention provides a lamination that includes a base of an extremely lightweight and strong, preferably thermoplastic composite material.

Thus, the present invention provides a lightweight, inexpensive durable material, such as body armor material, that can be formed in many different shapes and sizes to meet various NIR-compliant body armor needs.

Therefore, an object of the invention is to provide an NIR-compliant material for armor that is superior to known NIR-compliant materials.

There is an object of the invention to provide a lightweight NIR-compliant material that is durable in construction.

A further object of the invention is to provide a manufacturing process that has less steps than known processes for manufacturing NIR-compliant articles and materials.

Another object of the present invention is to provide NIR-compliant articles and materials that are less expensive than currently know articles and materials.

are too heavy, use too much material, are not durable and has too many

Yet another object of the present invention is to reduce delamination in end items.

### BRIEF DESCRIPTION OF THE DRAWING FIGURE

Further advantages, features and possible applications of the present invention are shown and described in the accompanying drawing figures.

FIG. 1 shows a perspective view of the laminated composition made in accordance with the present invention;

FIG. 2 shows a cross-sectional view through the line 2-2 of FIG. 1;

FIG. 3 shows an exploded perspective view of the layup of the composition of FIG. 1;

FIG. 4 shows a flow chart of the method of manufacturing the composition of the present invention; and

FIG. 5 shows the formation of the finished composition into a body armor vest in accordance with the present invention.

### DESCRIPTION OF THE INVENTION

As shown in the attached figures, the method and lamination composition of the present invention is shown and discussed in detail.

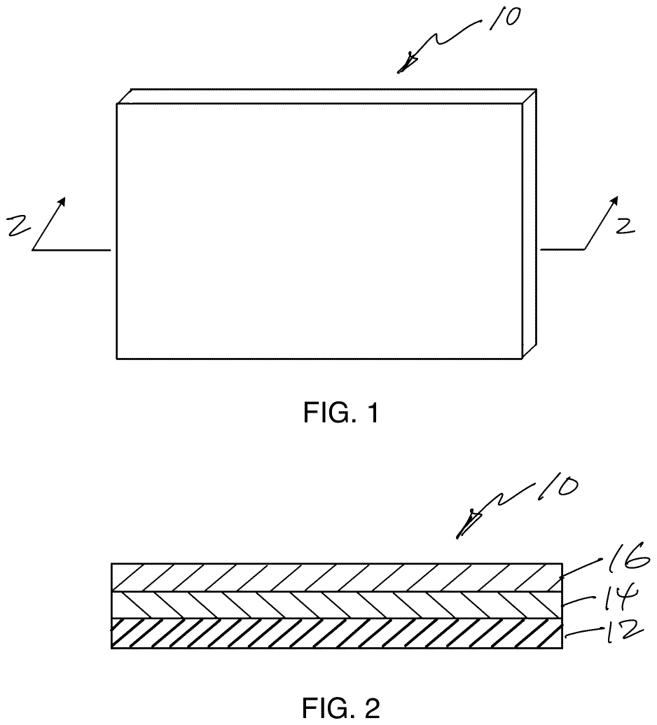

Referring first to FIG. 1, a completed composition 10 of the present invention is shown to illustrate the new and novel features of the present invention. For example, as discussed herein, the composite 10 includes a main body that is substantially planar with a front face, rear face (not shown in FIG. 1) and peripheral edges. As will be discussed in detail below, composition stock can then be formed, cut, finished, sewn, into any desired configuration for use in a given end application, such as body armor.

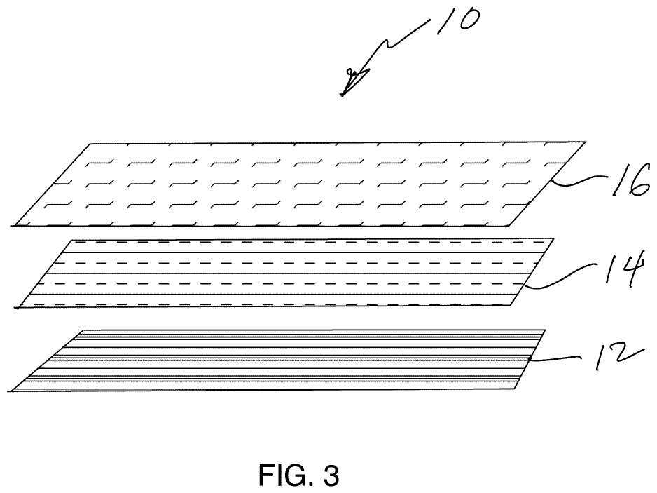

Turning now to FIG. 2, a cross-sectional view through the line 2-2 of FIG. 1 is shown. For ease and simplification of illustration, the cross-section shows the planar layup 10 of the materials used in the present invention. It should be understood that FIG. 2 is not to scale to show the individual layers enlarged so each layer can be clearly viewed. For example, the lamination composition can be any thickness to result in a flexible fabric-like stock material 10. Sample dimensions of each layer of the composition are discussed below. For further illustration, FIG. 3 shows the layers of FIG. 2 in an exploded perspective view.

Referring now to FIGS. 2 and 3, the lamination composition 10 of the present invention is discussed in detail.

The composite 10 of the present invention includes a base layer 12 of self-reinforced polypropylene that is laminated to a NIR-compliant stretch woven nylon 16 using a heat fusable web 14 residing therebetween. The fusable web 14 is preferably a heat-activated, sheet-like adhesive that bonds two components together without fasteners, sewing or the like.

More specifically, the base 12 is an extremely lightweight and strong, preferably thermoplastic composite material, which is preferably a layer of self-reinforced polypropylene. For example, in accordance with the present invention, the base layer 12 is preferably a lightweight, self-reinforced, high energy absorption and shock resistant, thermoplastic composite material made from heat-compacted woven polypropylene fibers that has superior impact strength and the ability to be pressure-thermoformed into rigid shapes. For example, the thickness of the base layer 12 may be any thickness to suit the application and needs at hand.

For such a base layer 12, typically, polypropylene granules are melted into thin sheets and then cut into strands, which are then stretched significantly to increase their strength and create highly molecularly oriented polypropylene fibers. The stretched fibers are woven together to form a self-reinforced polypropylene fabric layer 12.

Thus, the base layer 12 used in the composition 10 and method of the present invention achieves its strength comes from the inherent polypropylene fibers, requiring no additional support structures. As a result, it offers excellent energy absorption and shock resistance, making it resistant to damage, even at low temperatures and is significantly lighter than traditional materials like aluminum and fabric. Since the material of the base layer 12 is thermoformable, it can be molded into complex shapes under heat and pressure, making it versatile for design. For example, such a base layer is well-suited for use in high energy absorption applications, such as personal protection in the form of body armor. It may be cut and sewn into tactical gear, such as vests.

The base layer material 12 is durable and is inert so it is impervious to most solvents and offers superior resistance to permanent bending or splintering compared to other known materials.

For example, a thermoplastic composite base layer 12 is preferably CURV® material, sold by Propex Furnishing Solutions, Inc. While such a thermoplastic composite material is preferred for the base layer 12 of the present invention, other thermoplastic composite materials may be used and still be within the scope of the present invention.

Then, the base layer 12 of self-reinforced polypropylene substrate is laminated to a printed NIR-compliant stretch woven nylon layer 16 where a heat fusable web 14, residing therebetween, is used to secure the above two layers together by the use of heat to heat activate the bonding of the base layer 12 and NIR-compliant stretch woven nylon layer 16. The NIR-compliant stretch woven nylon layer 16 may be any type of fabric, loop or other item (alone or in combination with each other) that is secured to the CURV® base material to maintain NIR compliance. The NIR-compliant stretch woven nylon material 16 may be any type of such material, such as SemiDull D-STRETCH fabric. For example, the printed NIR-compliant stretch woven nylon layer 16 may be any thickness to suit the application and needs at hand. Also, the heat fusable web 14 may be any thickness to suit the application at hand.

As to strength, the material of the lamination composition 10 of the present invention can provide exceptional strength over 190 LB tensile strength for MOLLE applications in accordance to milspec specifications.

This lamination composition 10 results in flat sheets of material that are easily and quickly laser cut on a flat bed laser cutter in patterns and shapes as desired for the given application and armor configuration at hand. This process greatly reduces the number of sewing steps and raw materials required compared to known processes.

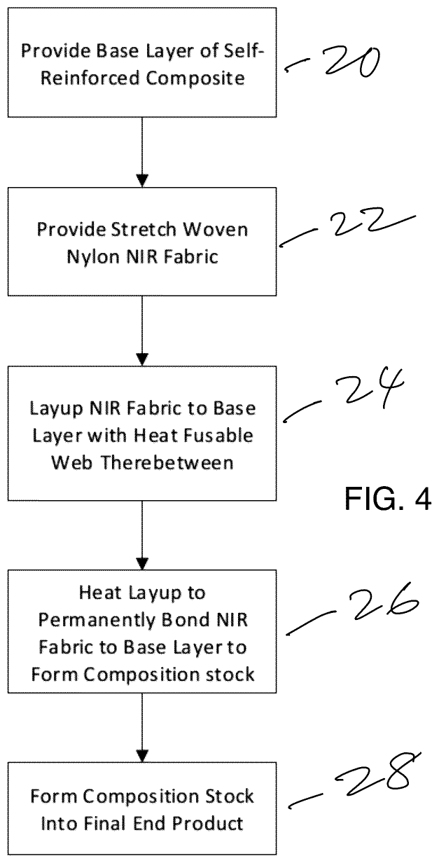

Referring now to FIG. 4, the steps of manufacturing the composition of the present invention is shown in detail.

At 20, the self-reinforced polypropylene base layer 12 is first provided in the configuration, as desired. Then, as a second step 22, a nylon NIR-compliant and stretch woven nylon layer 16, or any type of fabric, loop or other item alone or in combination with each other, is provided. At 24, the NIR-compliant and stretch woven nylon layer 16 is secured to the base material 12 using, preferably, a heat fusable web 14, which is a heat-activated, double-sided adhesive material to permanently bond components 12, 16 together without fasteners, sewing, or the like. The base material 12 and the NIR-compliant and stretch woven nylon material 16 are laminated to each other with the heat fusable web residing therebetween. At 26, heat is applied to activate the adhesive properties to thereby permanently bond the NIR-compliant and stretch woven nylon layer 16 to the base material 12 of self-reinforced polypropylene to provide the unfinished composition lamination 10 that is next configured into its final end form for use.

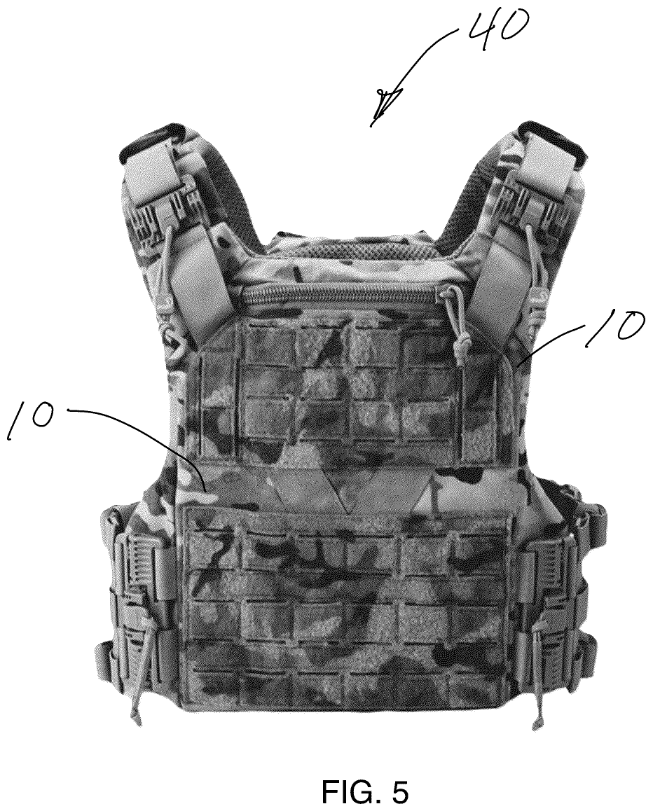

In the final processing step 28, the unfinished composition lamination 10 of the present invention is cut, further formed and modified as desired to configure it for its end intended use. For example, as seen in FIG. 5, the composition 10 of the present invention is cut, such as by laser or other method, to provide the final desired shape 40, which is a tactical vest in this example. In FIG. 5, the desired shape is of a tactical body armor vest 40 so it may be worn by military personnel, and the like. The body armor vest 40 includes outer layers that include the composition 10 of the present invention to provide the tactical gear for personal protection. The composition 10 may be cut, such as by laser cutting, and otherwise constructed to create the tactical body armor vest configuration 40 or any other tactical gear that requires NIR compliance. The configuration of tactical body armor vests are so well known in the art that further details need not be discussed herein. Suffice it to say that the composition 10 of the present invention is used in the construction of such a body armor vest 40, namely at its outer facing structure so it may provide the NIR compliance so the wearer thereof can blend into a surrounding environment.

Therefore, the present invention provides a unique composite material 10 that combines the strengths of self-reinforced polypropylene 12 and NIR-compliant stretch woven nylon 16, resulting in lightweight, durable, and near-infrared compliant tactical gear products, such as a vest 40. The simplicity of manufacturing single-piece gear products using this invention further enhances its value and practicality. Thus, the material of the present invention can be easily used for any type of body armor that requires NIR compliance. Moreover, different types of NIR compliance can be provided by simply laminating a stretch woven nylon layer that has a different NIR pattern. Thus, the present invention can be easily modified to meet different NIR compliance needs for different environments.

The aforesaid examples are only one of the optimal modes of execution of the present invention and common changes and substitutes made by technical personnel of this field within the technical proposal of this invention should be included in the protection scope thereof. It would be appreciated by those skilled in the art that various changes and modifications can be made to the illustrated embodiments without departing from the spirit of the present invention. All such modifications and changes are intended to be covered by the appended claims.

What is claimed is:

1. A method of manufacturing a near-infrared laminated material composition, comprising the steps of:
providing a base layer of self-reinforced polypropylene;
providing a NIR-compliant layer of material; and
laminating the base layer to the NIR-compliant layer.

2. The method of claim 1, wherein the step of laminating the base layer to the NIR-compliant layer includes positioning a heat fusable web between the base layer and the NIR-compliant layer to form a layup and then heating the layup to bond the base layer to the NIR-compliant layer.

3. The method of claim 1, wherein the NIR-compliant layer of material is a stretch woven nylon, a fabric, loop, and any combinations thereof.

4. The method of claim 1, wherein the base layer is CURV material.

5. The method of claim 1, further comprising the step of forming the composition into tactical gear or body armor.

6. The method of claim 1, wherein the tactical gear or body armor is a tactical body armor vest.

7. The method of claim 1, wherein the layer of stretch woven nylon has a NIR compliance pattern thereon.

8. A near-infrared laminated material composition, comprising:
a base layer of self-reinforced polypropylene;
a NIR-compliant layer of material;
a fusable web residing between the base layer and the NIR-compliant layer of material;
wherein the base layer is bonded to the NIR-compliant layer of material.

9. The composition of claim 8, wherein the NIR-compliant layer of material is a stretch woven nylon, a fabric, loop, and any combinations thereof.

10. The composition of claim 8, wherein the layer of stretch woven nylon has a NIR compliance pattern thereon.

11. The composition of claim 8, wherein the base layer is CURV material.
